(19) United States
(12) Patent Application Publication
(10) Pub. No.: US 2025/0314339 A1
(43) Pub. Date: Oct. 9, 2025

(54) Non-Threaded Quick-Connect for Threaded Coupling

(71) Applicant: Clayton Corporation, Fenton, MO (US)

(72) Inventor: James David Wilson, II, Collinsville, IL (US)

(21) Appl. No.: 19/172,511

(22) Filed: Apr. 7, 2025

Related U.S. Application Data
(60) Provisional application No. 63/575,396, filed on Apr. 5, 2024.

(51) Int. Cl. F16L 37/00; F16L 37/56

(52) U.S. Cl. CPC F16L 37/002; F16L 37/56

(57) ABSTRACT

A quick-connect fluidly and sealingly connects a source of pressurized fluid to a threaded female coupling. A coupling fixture removably holds the threaded female coupling. A male coupling is insertable into the threaded female coupling. A clamp operatively connects to the male coupling. The clamp linearly moves relative to the coupling fixture to insert the stem of the male coupling into the threaded female coupling. The clamp imparts sealing and non-threaded engagement of the one male coupling with the threaded female coupling to create a fluid-tight seal therebetween.

### CROSS-REFERENCE TO RELATED APPLICATIONS

The present application claims priority to U.S. Provisional Application Ser. No. 63/575,396, filed Apr. 5, 2024, the entirety of which is hereby incorporated by reference.

### FIELD OF THE DISCLOSURE

The present disclosure generally relates to a quick-connect device configured to sealingly and fluidly couple to a threaded female coupling without threadably engaging the threads of the threaded female coupling.

### BACKGROUND OF THE DISCLOSURE

A source of pressurized fluid may be connected to a system or device using threaded male and female couplings, also known as fittings.

### SUMMARY OF THE DISCLOSURE

In one aspect, a quick-connect is configured to fluidly and sealingly connect a source of pressurized fluid to at least one threaded female coupling. The quick-connect device comprises a coupling fixture configured to removably hold the at least one threaded female coupling; at least one male coupling insertable into the at least one threaded female coupling; and a clamp operatively connected to the at least one male coupling. The clamp is configured to linearly move relative to the coupling fixture to insert the stem of the at least one male coupling into the at least one threaded female coupling. The clamp is configured to impart sealing and non-threaded engagement of the at least one male coupling with the at least one threaded female coupling to create a fluid-tight seal therebetween.

Other features are shown and described herein.

### BRIEF DESCRIPTION OF THE DRAWINGS

FIG. 1 is a perspective of a quick-connect device configured to fluidly and sealingly connect a source of pressurized fluid to at least one threaded female coupling without threadably engaging internal threads of the threaded female coupling, the quick-connect device being in an unlocked position.

FIG. 2 is an enlarged exploded elevation of a male coupling of the quick-connect device.

FIG. 3 is a cross section of the male coupling disconnected from a threaded female coupling.

FIG. 4 is a cross section of the male coupling fluidly and sealingly connected to the threaded female coupling.

FIG. 5 is an elevational view of the quick-connect device.

FIG. 6 is an enlarged, exploded perspective of a coupling fixture of the quick-connect device.

FIG. 7 is an enlarged perspective of the coupling fixture showing a threaded female coupling removed therefrom.

FIG. 8 is similar to FIG. 1 with the quick-connect device being in a locked position.

### DETAILED DESCRIPTION OF THE DISCLOSURE

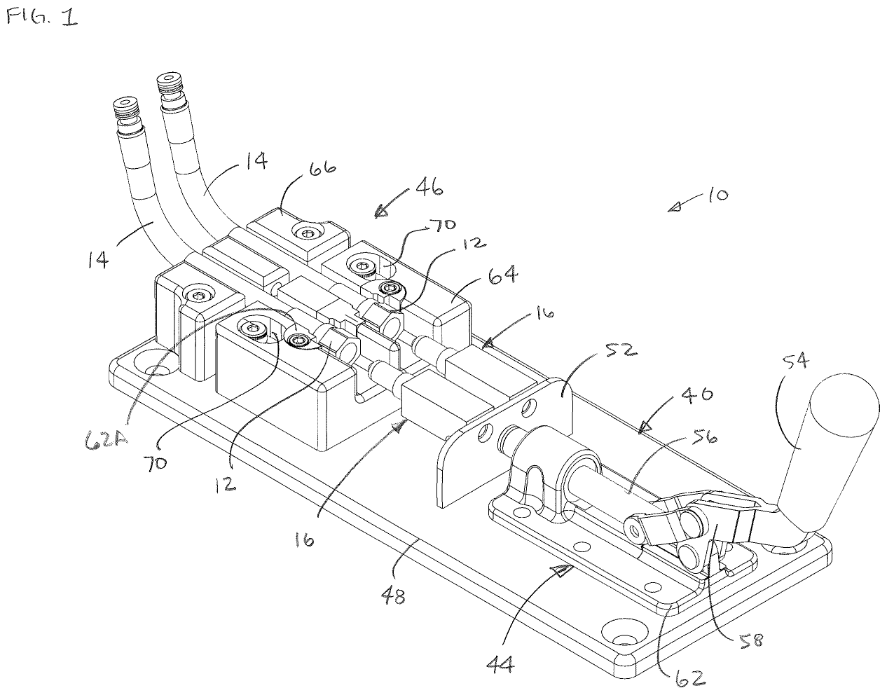

Referring to FIG. 1, a quick-connect device is generally indicated at reference numeral 10. The fluid quick-connect device 10 is configured to fluidly and sealingly connect a source of pressurized fluid (not shown; e.g., gas, liquid, or other flowable substance) to at least one threaded female coupling 12 without threadably engaging internal threads of the threaded female coupling. In this way, the fluid quick-connect device 10 can be quickly connected and quickly disconnected from the threaded female coupling 12. In one example, such as illustrated, the threaded female coupling 12 may be a JIC fitting, having a tapered internal seat (e.g., 37 degree tapered seat).

In one example, the threaded female coupling 12 is fluidly connected to a conduit 14 (e.g., tubing, line, pipe, etc.), which may be in turn be fluidly connected or configured to be fluidly connected to a system that receives the pressurized fluid. The system may be any device, assembly, machine, etc. configured to receive fluid, such as hydraulic, pneumatic, or other fluid applications. Such systems may include pressure vessels, fluid lines, hydraulic aggregates/hydraulic pumps/hydraulic blocks, pneumatic components, air engines, engine/engine blocks, cylinder blocks/cylinder heads, injector pumps, steering racks, cylinders and automotive components, automatic production test benches, automated test systems, robotics, batteries, electric motors, cooling and water connections as well as oil modules of electric motors, inverters, power electronics, solar batteries, aluminum boxes with lithium-ion accumulators. The illustrated example is suitable for testing a system for leaks or pressure testing within the system.

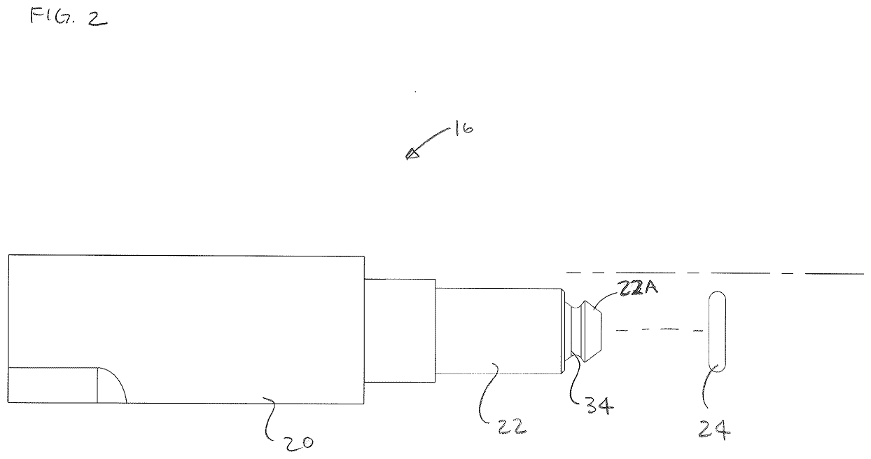

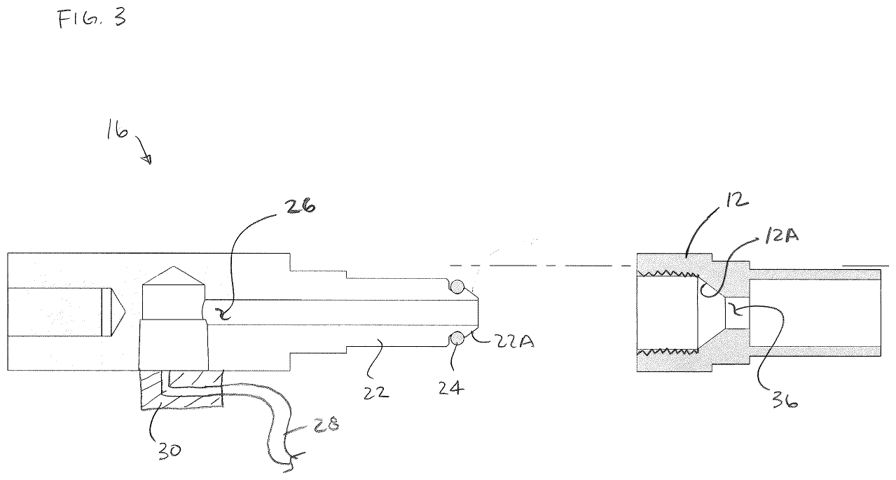

Referring to FIGS. 2-4, the fluid quick-connect device 10 includes at least one male coupling, generally indicated at 16, that is configured to be slidably inserted into the threaded female coupling 12 and sealingly, non-threadably engage an interior surface (e.g., a non-threaded portion of the interior surface) of the threaded female coupling. As used herein, “non-threadably engage” or “non-threaded engagement” means that the male coupling 16 does not engage internal thread(s) of the threaded female coupling 12 to fluidly connect the male coupling to the female coupling. The illustrated male coupling 16 includes a coupling body 20, a stem 22 extending from the coupling body, and a seal 24 (e.g., annular seal or O-ring) secured to the stem adjacent a distal end thereof. A fluid passage 26 extends from the coupling body 20, into the stem 22, and through the distal end of the stem. Referring to FIG. 3, tubing 28 is fluidly connected to the fluid passage 26, such as by a fluid adapter 30 secured to a side of the coupling body 20, to deliver pressurized fluid from the fluid source into the coupling body, through the passage 26, and into the threaded female coupling 12.

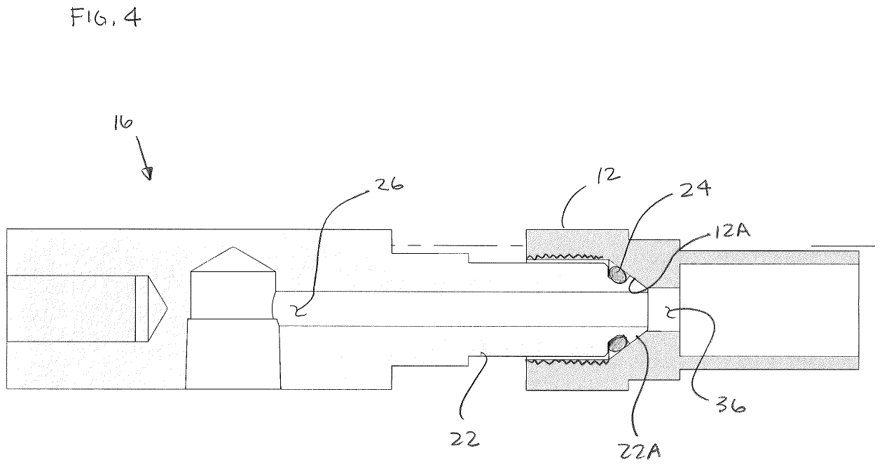

Referring still to FIGS. 2-4, the stem 22 is unthreaded and has an outer diameter less than a minimum inner diameter of the threaded female coupling 12 to enable the stem to be inserted into the threaded female coupling. The seal 24 is annular and elastically deformable (e.g., elastically compressible) and surrounds the stem 22 adjacent the distal end thereof. The seal 24 is received in an annular groove 34 defined by the stem 22 (FIG. 2). Referring to FIG. 4, when the stem 22 is inserted into the threaded female coupling 12, the seal 24 engages the non-threaded portion 12A of the interior of the threaded female coupling, thereby suitable compressing the seal, to form an annular fluid-tight seal around the interior of the threaded female coupling, and the fluid passage of the male coupling 16 is in sealed, fluid communication with a female fluid passage 36 defined by the threaded female coupling (and a fluid passage defined by any fluid conduit fluidly connected to the threaded female coupling). In the illustrated embodiment, the distal end margin of the stem 22 “bottoms out” in the threaded female coupling. In particular, the distal end margin 22A of the illustrated stem 22 is chamfered or tapered to correspond to an internal taper (i.e., seat) of the unthreaded portion 12A of the interior surface of the threaded female coupling 12. This enhances compression of the annular seal 24 against the tapered, unthreaded portion 12A of the interior surface of the threaded female coupling 12, thereby enhancing the fluid-tight seal.

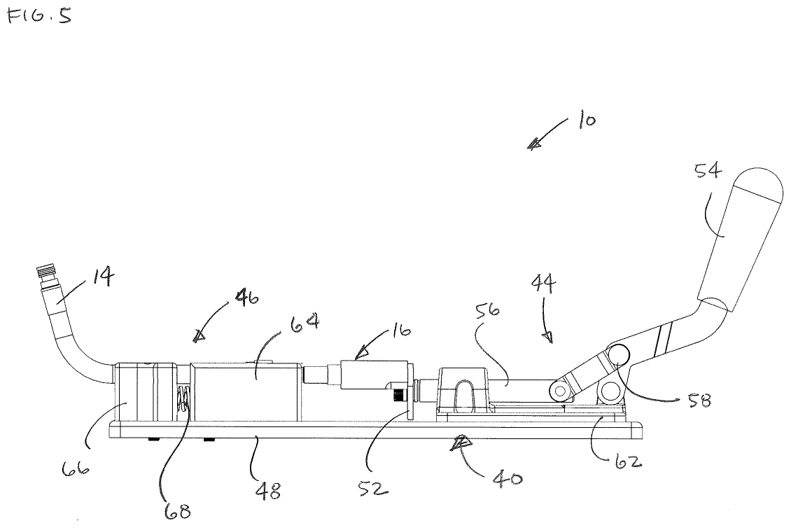

Referring to FIGS. 1 and 5, in the illustrated embodiment, the quick-connect device 10 further includes a press, generally indicated at 40, configured to enable fluid coupling of the at least one male coupling 16 with the at least one threaded female coupling 12. In particular, the press 40 is configured to impart suitable sealing force between the seal 24 and the tapered, unthreaded portion 12A of the interior surface of the threaded female coupling 12 to suitably compress the seal to form the fluid-tight seal. The press 40 includes a clamp (e.g., manual or automated), generally indicated at 44, and a coupling fixture, generally indicated at 46, each of which is mounted on a body 48 (e.g., plate).

Referring still to FIGS. 1 and 5, the clamp 44 includes a movable jaw 52 on which the at least one male coupling 16 is attached (e.g., mounted). The illustrated clamp 44 is a toggle clamp (e.g., push pull toggle clamp) and also includes a linearly movable clamping arm 56 on which the movable jaw 52 is attached, a handle 54 to manually operate the clamp, a linkage 58 to convert rotational movement of the handle into linear movement of the clamping arm and jaw, and a base 62 for mounting the clamp on the body 48 of the press 40. Rotation of the handle 54 imparts linear translation of the at least one male coupling 16 relative to the body 48 and the coupling fixture 46. A solenoid or other actuator may be used in place of the handle 54 and linkage 58.

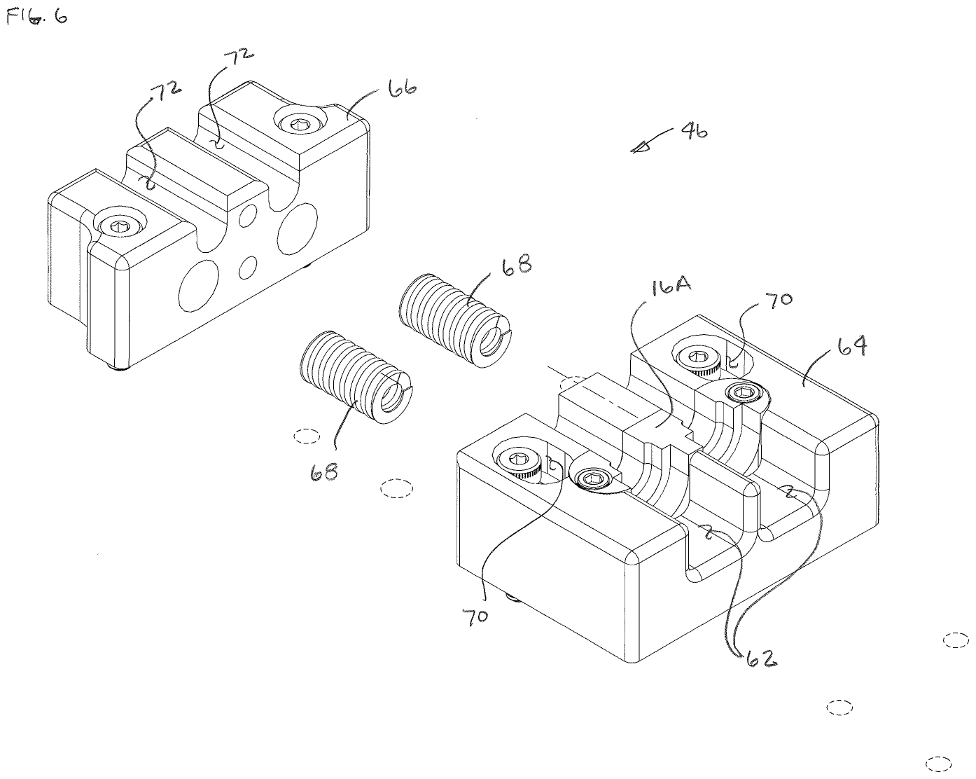

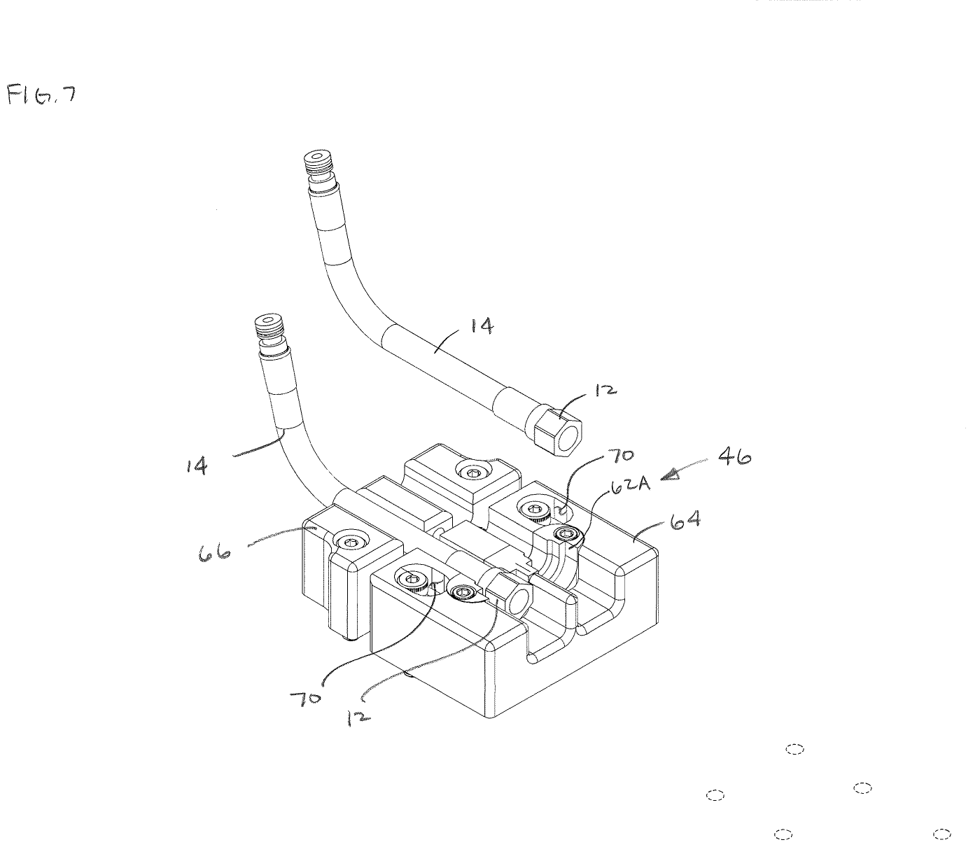

Referring to FIGS. 1, 6, and 7, the coupling fixture 46 is configured to removably hold the at least one threaded female coupling 12 in alignment with the at least one male coupling 16 to enable the at least one male coupling to be pressed into the at least one female coupling using the clamp 44. The illustrated coupling fixture 46 defines at least one coupling cavity 62 sized and shaped to removably receive the at least one threaded female coupling 12 therein. The coupling cavity 62 may be at last partially defined by a removable insert 62A to enable different types/sizes of threaded female couplers to be held by the coupling fixture 46. The illustrated coupling fixture 46 includes a movable coupling holder 64, which defines the at least one coupling cavity 62, a stop 66 distal of the coupling holder, and at least one spring 68 (broadly, a resilient biasing member) disposed between the coupling holder and the stop. The coupling holder 64 is slidably mounted on the body 48 of the press 40, such as by fasteners received in slots 70 (openings) defined by the coupling holder, for selective, limited movement in a distal-proximal direction. The stop 66 is fixedly connected to the body 48, such that the spring 68 (e.g., compression spring) resiliently biases the coupling holder 64 and the at least one threaded female coupling 12 in a proximal position (i.e., toward the male coupling 16). In the illustrated embodiment, the stop 66 defines at least one conduit cavity 72 for removably holding the at least one conduit attached to the at least one threaded female coupling 12.

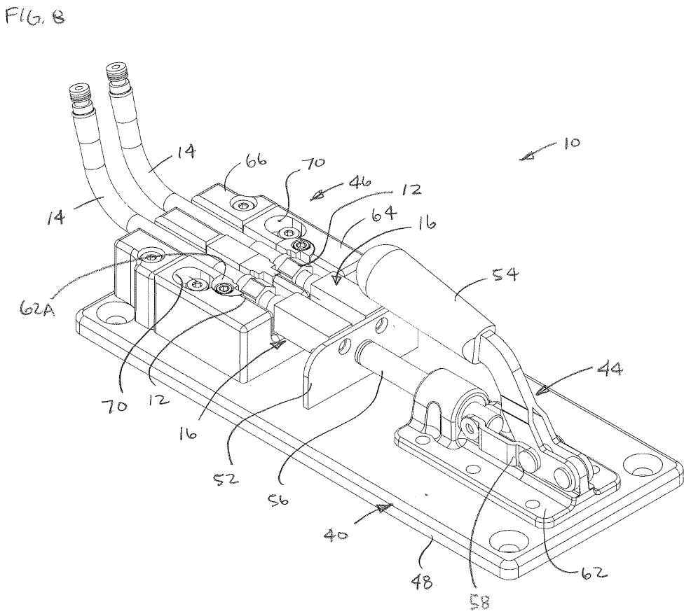

In operation, as shown in FIG. 1, the at least threaded female coupling 12 is brought into engagement with the coupling fixture 46 so that the threaded female coupling is releasably held by the coupling fixture (e.g., the threaded female coupling is removably inserted into the coupling cavity 62 of the coupling holder 64). The threaded female coupling 12 may be fluidly connected to a system for receiving fluid therein. The conduit 14 may fluidly connect the female coupling 12 to the remainder of the system, or the system may not include the conduit. A shown in FIG. 8, the clamp 44 is actuated, such as by rotating the handle 54 to impart linear translation of the male coupling 16 relative to the body 48, the coupling fixture 46, and the threaded female coupling 12 being held by the coupling fixture 46. The male coupling 16 enters the threaded female coupling 12 and the seal 24 compresses and seats against the unthreaded portion of the interior surface of the threaded female coupling 12. As the male coupling 16 continues to translate and the seal 24 compresses against the interior of the female coupling 12 (FIG. 4), the coupling holder 64 may slide distally against the bias force of the spring 68 until the clamp 44 releasably locks (e.g., the throw of the handle 54 reaches its maximum extent) to inhibit the clamp male coupling from moving proximally, as shown in FIG. 8. The biasing force of the spring 68 maintains suitable compression of the seal 24 to form the fluid-tight seal between the male coupling 16 and the threaded female coupling 12. This design enables use of the quick-connect device 10 with threaded female couplings 12 having certain dimensional tolerances.

With the male coupling 16 in fluid connection with the threaded female coupling 12, the pressurized fluid is introduced into the male coupling, through the female coupling, and into the system. In one example, the device 10 is configured to use in leak or pressure testing of the system. In this example, after testing, the male coupling 16 is withdrawn from the female coupling 12, such as by rotating the handle 54, and another female coupling associated with another system is brought into engagement with the coupling fixture 46 for testing. The device 10 may be used in other applications for making fluid connection with a threaded female coupling without threadably engaging the threaded female coupling.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A quick-connect device configured to fluidly and sealingly connect a source of pressurized fluid to at least one threaded female coupling, the quick-connect device comprising:
a coupling fixture configured to removably hold the at least one threaded female coupling;
at least one male coupling insertable into the at least one threaded female coupling; and
a clamp operatively connected to the at least one male coupling, wherein the clamp is configured to linearly move relative to the coupling fixture to insert the stem of the at least one male coupling into the at least one threaded female coupling,
wherein the clamp is configured to impart sealing and non-threaded engagement of the at least one male coupling with the at least one threaded female coupling to create a fluid-tight seal therebetween.

2. The quick-connect device set forth in claim 1, wherein the at least one male coupling includes a stem and a seal attached to a distal end of the stem, wherein the clamp is configured to compress the seal against a non-threaded portion of an interior surface of the at least one threaded female coupling.
